(19) United States
(12) Patent Application Publication
(10) Pub. No.: US 2020/0114620 A1
(43) Pub. Date: Apr. 16, 2020

(54) FIREPROOF AND THERMAL INSULATOR PRODUCT

(71) Applicants: Airbus Operations SAS, Toulouse (FR); Airbus Operations, S.L., Getafe (ES)

(72) Inventors: Olivier BARBARA, TOULOUSE (FR); Diego GARCIA MARTIN, GETAFE (ES); Guillermo HERNAIZ LOPEZ, GETAFE (ES); Tamara BLANCO VARELA, GETAFE (ES); Jesus Javier VAZQUEZ CASTRO, GETAFE (ES)

(21) Appl. No.: 16/596,889

(22) Filed: Oct. 9, 2019

(30) Foreign Application Priority Data
Oct. 11, 2018 (EP) 18382723.7

(51) Int. Cl. B32B 5/26; B32B 7/12; B32B 27/12; B32B 15/20

(52) U.S. Cl. CPC B32B 5/26; B32B 7/12; B32B 27/12; B32B 15/20; B32B 2307/304; B32B 2250/03; B32B 2605/18; B32B 2262/0223; B32B 2262/101; B32B 2262/106; B32B 2262/103; B32B 2307/3065

(57) ABSTRACT

A fireproof and thermal insulator product, which comprises a material combination of an Earth Silicate material, and alumina, such that the alumina is bonded onto the Earth Silicate material or is diffused inside the Earth Silicate material.

### CROSS-REFERENCES TO RELATED APPLICATIONS

This application claims the benefit of the European patent application No. 18382723.7 filed on Oct. 11, 2018, the entire disclosures of which are incorporated herein by way of reference.

### FIELD OF THE INVENTION

This invention refers to a product that provides structures and associated systems with protection against the consequences of a fire event, particularly flame penetration, and that also provides thermal insulation capability. The invention is particularly applicable in aircraft.

### BACKGROUND OF THE INVENTION

Many parts of the aircraft are submitted to fire events, and in order to ensure the normal operation of the aircraft, structure and associated systems have to be protected against the fire event consequences.

For these purposes several materials and solutions have been tested and installed to prevent the consequences of fire events. Two main effects need to be solved depending on the application: flame penetration and thermal insulation.

The flame penetration issue needs to be addressed keeping the fire enclosed in the designated area. On the other hand, the thermal insulation capability may allow the use of a wide range of materials for the structural applications having less decoupling temperature requirements.

An option widely used is the thermal blankets, mainly made of ceramic or silicone laminates with aluminum sheet. They are effective for flame penetration and thermal insulation, but are also expensive and heavy.

Some materials work against a fire event creating a charred layer of material which is porous, preventing flame penetration and providing insulation. This option is quite relevant in many cases due to its performance. However, structures submitted to vibrations cannot implement this solution due to the fact that the protection will be lost under operation conditions.

Adding materials like titanium whose fire resistance capability is much higher than the structural material to overcome the flame penetration issue has been widely used. As an example, the APU of an aircraft can be surrounded by a titanium firewall to prevent the aluminum, which acts as structural material, from being damaged, letting the fire come out of the tail cone in a fire event.

### SUMMARY OF THE INVENTION

An object of the present invention is to provide a product that is fireproof and has also good thermal insulation capability, which allows an avoidance of high temperatures at the structure around the fire source that could damage the structure.

The invention provides a fireproof and thermal insulator product comprising a material combination of:
an Earth Silicate material, and
alumina,

such that the alumina is bonded onto the Earth Silicate material or is diffused inside the Earth Silicate material.

The invention provides the following advantages:

Less weight than other fireproof standard materials and products.

Small thickness needed to accomplish its function.

Low cost.

Fireproofness capabilities ensured.

Low density.

Biodegradable Materials.

Health&Safety Compliant.

Environmentally Friendly.

Other characteristics and advantages of the present invention will be clear from the following detailed description of several embodiments illustrative of its object in relation to the attached figures.

### BRIEF DESCRIPTION OF THE DRAWINGS

FIG. 1 shows a schematic view of an embodiment of a fireproof and thermal insulator product of the invention.

FIG. 2 shows a schematic view of another embodiment of a fireproof and thermal insulator product of the invention.

FIG. 3 shows an example of the attachment of an embodiment of a fireproof and thermal insulator product of the invention to the main structure to be protected.

FIG. 4 shows another example of the attachment of an embodiment of a fireproof and thermal insulator product of the invention to the main structure to be protected.

### DETAILED DESCRIPTION OF THE PREFERRED EMBODIMENTS

It is important to take into account that the “fireproof” concept is defined by aeronautical regulations such as:

FAR/JAR25.1191: Firewalls-Definition.

FAR/JAR25.865: Fire Protection Of Flight Controls, Engine Mounts And Other Flight Structures.

The basic configuration of the fireproof and thermal insulator product 1 of the invention comprises a material combination of an Earth Silicate material (AES), and alumina, such that the alumina is bonded onto the Earth Silicate material or is diffused inside the Earth Silicate material.

This product stops the flame and avoids flame passing-through.

In an embodiment of the invention, the product 1 additionally comprises a cover 3. The purpose of the cover 3 is to protect the material combination of Earth Silicate material and alumina from aggressive fluids and water/humidity, that could potentially damage the fireproof behavior. It also avoids accidental damage (scratches, tear during assembly or in-service, etc.).

In an embodiment of the invention, the cover 3 completely surrounds the part 2 (constituted by the material combination of the Earth Silicate material and the alumina) by both faces and its edges (see FIG. 2).

The cover 3 can be made of any polyvinyl film, polyimide film, plastic film, glass fiber or carbon fiber, or can be a thin metal sheet.

In another embodiment of the invention, the product 1 additionally comprises a support 4 bonded or attached to the part 2 constituted by the material combination of the Earth Silicate material and the alumina. This support 4 provides means to attach the product 1 of the invention to the desired place. The support 4 also protects the material combination of Earth Silicate material and alumina from aggressive fluids and water/humidity, that could potentially damage the fireproof behavior, and also avoids accidental damage (scratches, tear during assembly or in-service, etc.).

The support 4 can be made of glass fiber or carbon fiber or can be a thin metal sheet, or a polyvinyl film

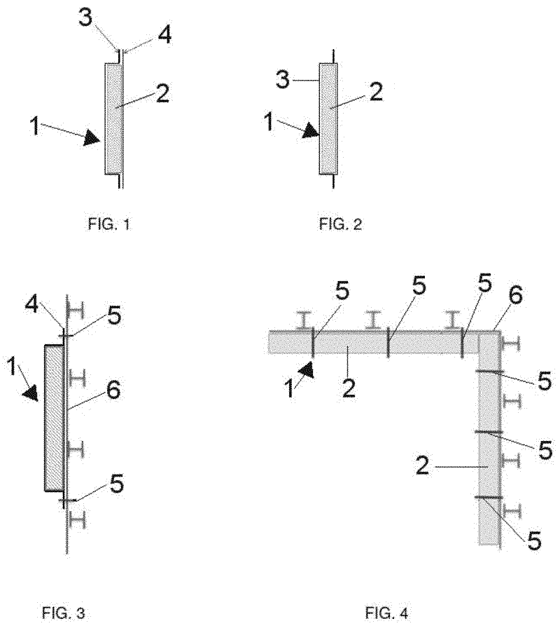

FIG. 1 shows a schematic view of an embodiment of a fireproof and thermal insulator product 1 of the invention with a cover 3 and a support 4.

In a specific embodiment, the support 4 is not needed, and the product 1 with the cover 3 is directly attached to the structure.

The Earth Silicate material and the alumina can be in the form of a layer, the alumina layer being bonded onto the Earth Silicate material layer.

The thickness of the Earth Silicate material is preferably between 2 mm and 20 mm thick, and the thickness of the alumina layer is preferably between 0.5 mm and 2 mm thick. Greater thicknesses can be used depending on the specific application, if needed.

More preferably, the thickness of the Earth Silicate material is preferably between 2 mm and 10 mm thick, and the thickness of the alumina layer is preferably between 0.5 mm and 2 mm thick.

In a specific embodiment the layer of Earth Silicate is 5 mm thick and the layer of alumina is 0.5 mm thick.

This specific material combination (Earth Silicate material of 5 mm thick+Alumina of 0.5 mm thick) has been tested fulfilling the FAR/JAR25 regulations regarding firewalls (FAR/JAR25.1191 & FAR/JAR25.865), that is:

Direct flame impingement for 15 min.

Calibrated Flame of 1100° C. at a distance of 100 mm from the specimen.

Calibrated Heat Flux.

Specimen under vibration of 50 Hz (reduced to 16.6 Hz after 5 min)

No load applied.

Material was bonded over a glass fiber laminate just for attachment to the test rig purposes.

The result after the 15 minutes required with the 1100° C. flame, was that not only was there no pass through of the flame, but also the temperature measured at the rear part of the specimen was lower than 60° C.

Furthermore, the attachment of the product 1 of the invention to the main structure 6 to be protected can be done by attaching the support 4 using attaching means 5, such as fasteners or bolts (see FIG. 3).

For the embodiments without any support 4, the attachment to the main structure 6 can be done directly through the part 2 constituted by the material combination of the Earth Silicate material and the alumina by means of fasteners, or any other attaching means 5 that does not tear out the part 2 constituted by the material combination of the Earth Silicate material and the alumina (see FIG. 4).

The product 1 of the invention is particularly applicable in aircraft. Specifically, it can provide fire protection, thermal protection or both protections to several elements of an aircraft, for example:

Section 19.1 Firewall (fire protection).

Pylon lower spar (thermal protection).

Pylon bleed area FSS, nacelle fan doors, nacelle Inner Fixed Structure & Bifi, EM thrust rods (thermal and fire protection for all of them).

The product 1 of the invention is also applicable to helicopter engine compartments, for example:

Engine deck.

Cowlings.

Although the present invention has been fully described in connection with preferred embodiments, it is evident that modifications may be introduced within the scope thereof, not considering this as limited by these embodiments, but by the contents of the following claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fireproof and thermal insulator product, which comprises a material combination of:
an Earth Silicate material, and
alumina,
wherein the alumina is bonded onto the Earth Silicate material.

2. The fireproof and thermal insulator product, according to claim 1, additionally comprising a cover.

3. The fireproof and thermal insulator product, according to claim 2, wherein the cover completely surrounds a part constituted by the material combination of the Earth Silicate material and the alumina.

4. The fireproof and thermal insulator product, according to claim 2, wherein the cover is made of any polyvinyl film, polyimide film, plastic film, glass fiber or carbon fiber, or it is a thin metal sheet.

5. The fireproof and thermal insulator product, according to claim 1, additionally comprising a support bonded or attached to a part constituted by the material combination of the Earth Silicate material and the alumina.

6. The fireproof and thermal insulator product, according to claim 5, wherein the support is made of glass fiber or carbon fiber, or it is a thin metal sheet, or a polyvinyl film.

7. The fireproof and thermal insulator product, according to claim 1, wherein the Earth Silicate material and the alumina are each formed as a layer.

8. The fireproof and thermal insulator product, according to claim 7, wherein the layer of Earth Silicate is between 2 mm and 20 mm thick, and the layer of alumina is between 0.5 mm and 2 mm thick.

9. The fireproof and thermal insulator product, according to claim 8, wherein the layer of Earth Silicate is between 2 mm and 10 mm thick.

10. The fireproof and thermal insulator product, according to claim 9, wherein the layer of Earth Silicate is 5 mm thick and the layer of alumina is 0.5 mm thick.

11. The fireproof and thermal insulator product, according to claim 1, further comprising means for attachment of the product to a main structure to be protected.

12. A fireproof and thermal insulator product, which comprises a material combination of:
an Earth Silicate material, and
alumina,
wherein the alumina is bonded onto the Earth Silicate material or is diffused inside the Earth Silicate material.

13. The fireproof and thermal insulator product, according to claim 12, additionally comprising a cover.

14. The fireproof and thermal insulator product, according to claim 13, wherein the cover completely surrounds a part constituted by the material combination of the Earth Silicate material and the alumina.

15. The fireproof and thermal insulator product, according to claim 13, wherein the cover is made of any polyvinyl film, polyimide film, plastic film, glass fiber or carbon fiber, or it is a thin metal sheet.

16. The fireproof and thermal insulator product, according to claim 12, additionally comprising a support bonded or attached to a part constituted by the material combination of the Earth Silicate material and the alumina.

17. The fireproof and thermal insulator product, according to claim 16, wherein the support is made of glass fiber or carbon fiber, or it is a thin metal sheet, or a polyvinyl film.

18. The fireproof and thermal insulator product, according to claim 12, further comprising means for attachment of the product to a main structure to be protected.
